(19) United States
(12) Patent Application Publication
(10) Pub. No.: US 2025/0078694 A1
(43) Pub. Date: Mar. 6, 2025

(54) Multimedia Gravesite Memorial Device

(71) Applicant: Todd Ware, Zanesville, OH (US)

(72) Inventor: Todd Ware, Zanesville, OH (US)

(21) Appl. No.: 18/240,116

(22) Filed: Aug. 30, 2023

(51) Int. Cl. G09F 27/00; E04H 13/00; G09F 7/20

(52) U.S. Cl. CPC G09F 27/007; E04H 13/001; G09F 7/20; G09F 2007/1804; G09F 2007/1873; G09F 2027/002

(57) ABSTRACT

A multimedia gravesite memorial device includes a multimedia unit that has a display for displaying imagery and a plurality of speakers for emitting audible sounds. The multimedia unit is in remote communication with a personal electronic device thereby facilitating the multimedia unit to store imagery of a loved one and audio of the loved one speaking such that the display can display the imagery of the loved and the plurality of speakers can emit the audio of the loved one speaking. A pole is pivotally mounted to the multimedia unit and the pole can be driven into the ground adjacent to a tombstone of the loved one thereby facilitating the multimedia unit to be visible to visitors of the tombstone such that the visitors can view the imagery of the loved one and hear the audio of the loved one speaking.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to gravesite memorial devices and more particularly pertains to a new gravesite memorial device for displaying imagery of a loved one and emitting audio of a loved one speaking. The device includes a multimedia unit that has speakers and a display and which is in remote communication with a personal electronic device to receive imagery and audio from the personal electronic device. The device includes a pole upon which the multimedia unit is mounted which can be driven into the ground next to a tombstone at a gravesite. The multimedia unit displays imagery of the decedent and audio of the decedent to enhance memorializing the decedent.

### (2) Description of Related Art Including Information Disclosed Under 37 CFR 1.97 and 1.98

The prior art relates to gravesite memorial devices including a variety of tombstone devices that each has multimedia capabilities for displaying imagery and emitting audio of a decedent and a variety of digital memorial devices that includes a book style multimedia device and a solar powered multimedia device that has proximity sensors for activation when a person approaches the multimedia device. In no instance does the prior art disclose a digital memorial device that includes a multimedia unit pivotally mounted to pole which can be driven into the ground next to a tombstone for enhancing memorializing the decedent and which is in wireless communication with a personal electronic device for downloading imagery and audible sound.

### BRIEF SUMMARY OF THE INVENTION

An embodiment of the disclosure meets the needs presented above by generally comprising a multimedia unit that has a display for displaying imagery and a plurality of speakers for emitting audible sounds. The multimedia unit is in remote communication with a personal electronic device thereby facilitating the multimedia unit to store imagery of a loved one and audio of the loved one speaking such that the display can display the imagery of the loved and the plurality of speakers can emit the audio of the loved one speaking. A pole is pivotally mounted to the multimedia unit and the pole can be driven into the ground adjacent to a tombstone of the loved one thereby facilitating the multimedia unit to be visible to visitors of the tombstone such that the visitors can view the imagery of the loved one and hear the audio of the loved one speaking.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a multimedia gravesite memorial device according to an embodiment of the disclosure.

FIG. 2 is a front phantom view of an embodiment of the disclosure.

FIG. 3 is a left side view of an embodiment of the disclosure.

FIG. 4 is a cross sectional view taken along line 4-4 of FIG. 3 of an embodiment of the disclosure.

FIG. 5 is a schematic view of an embodiment of the disclosure.

FIG. 6 is a perspective in-use view of an embodiment of the disclosure.

FIG. 7 is a back perspective view of an alternative embodiment of the disclosure.

FIG. 8 is an exploded in-use view of an alternative embodiment of the disclosure showing a multimedia unit being adhered to a tombstone.

FIG. 9 is a perspective in-use view of an alternative embodiment of the disclosure.

### DETAILED DESCRIPTION OF THE INVENTION

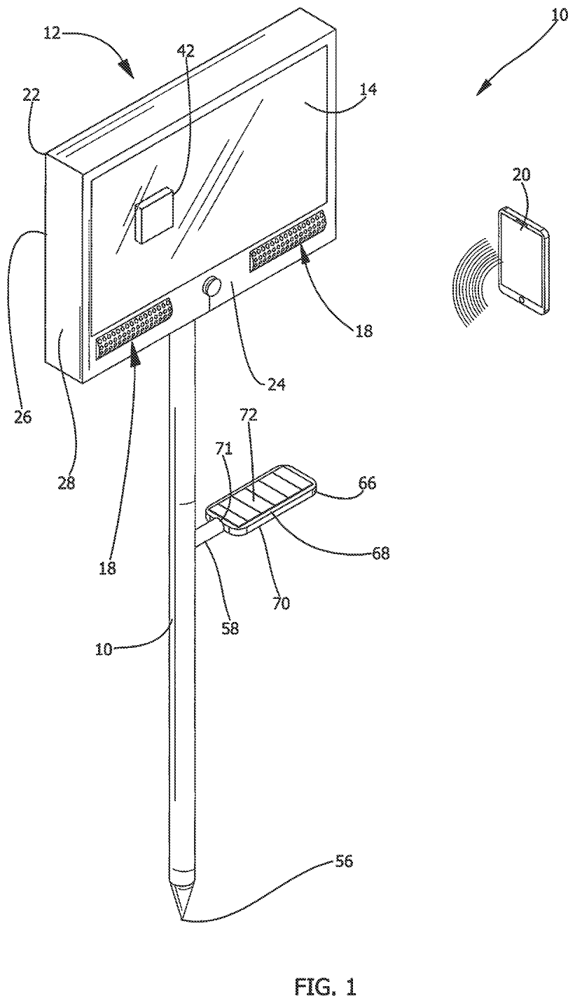

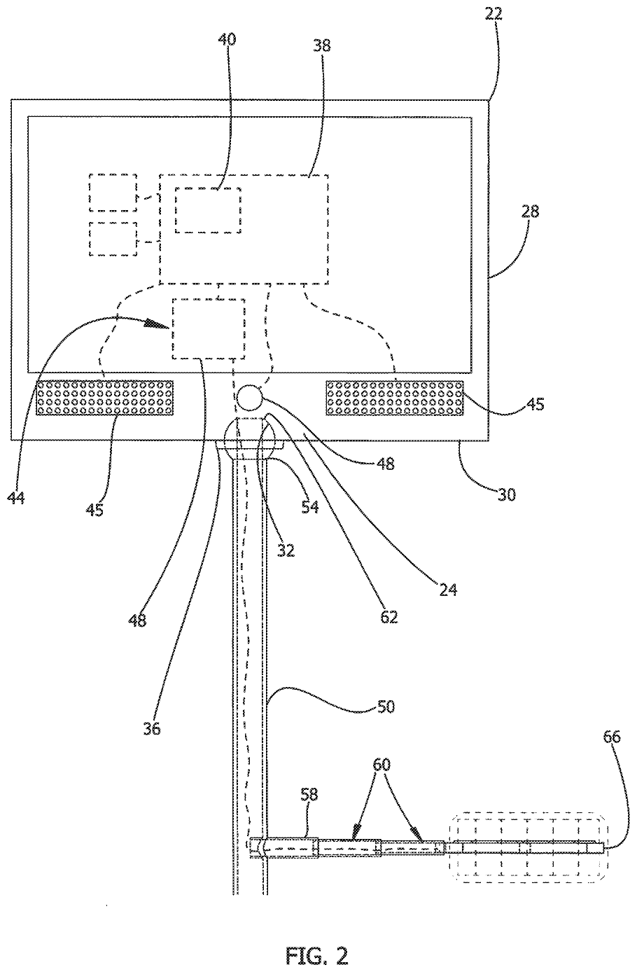

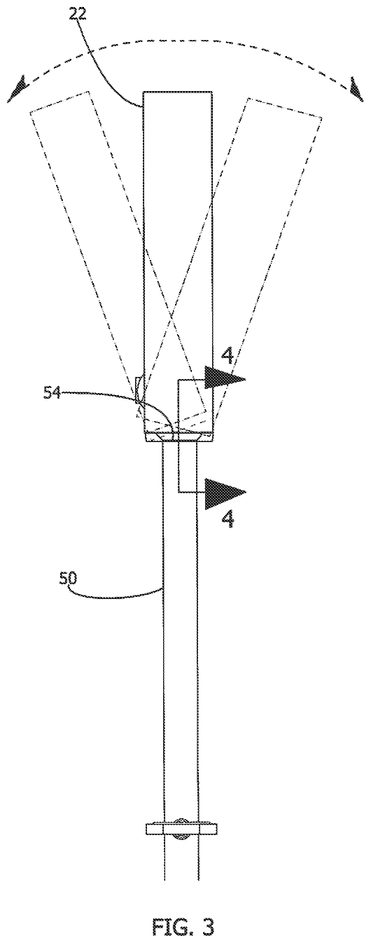

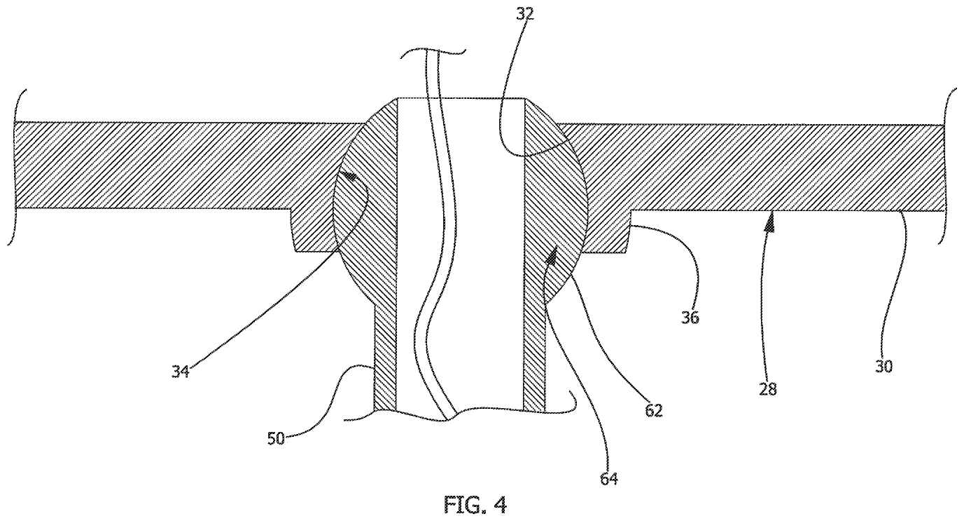

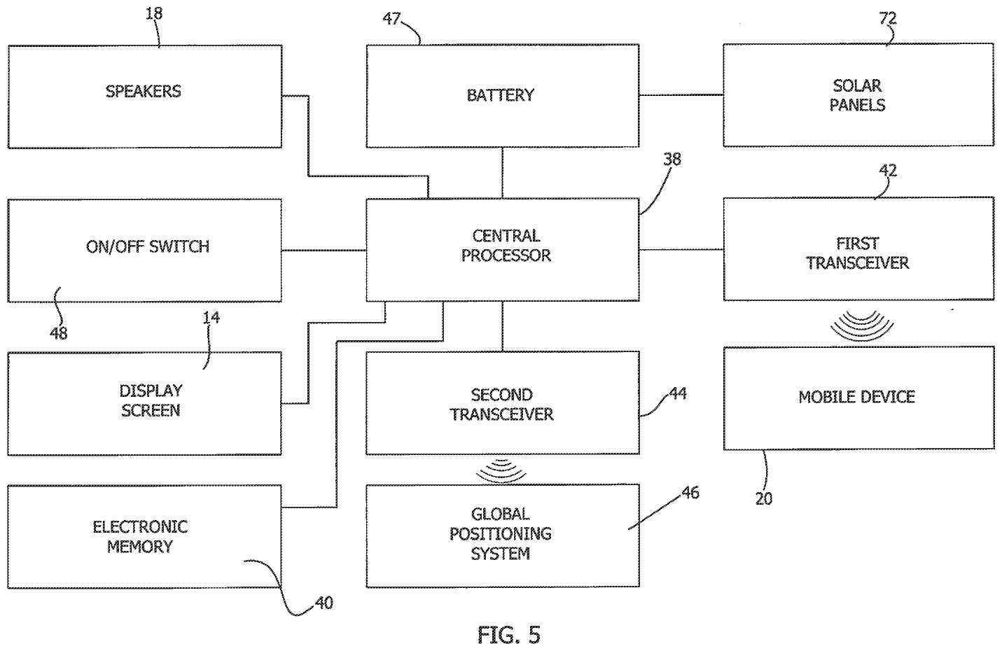

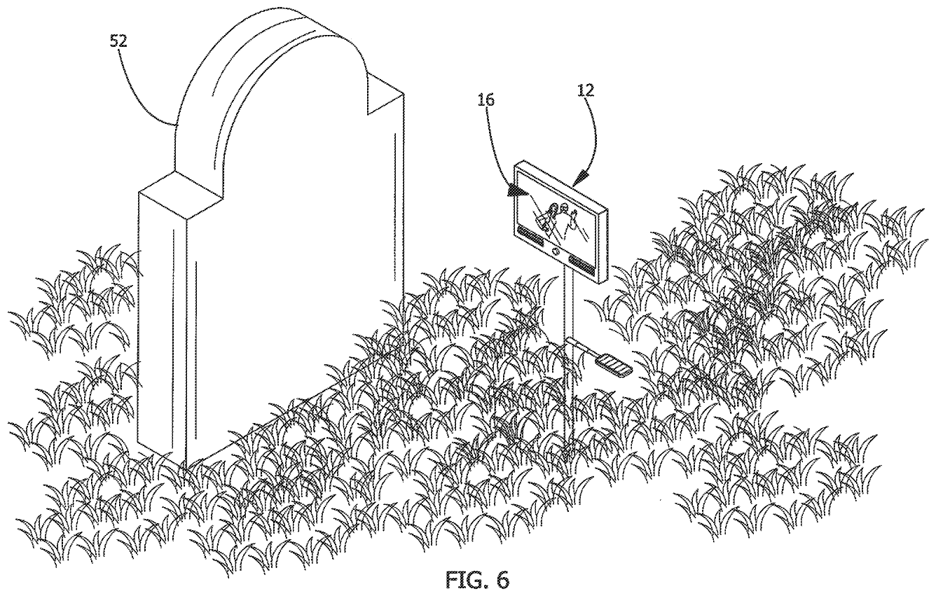

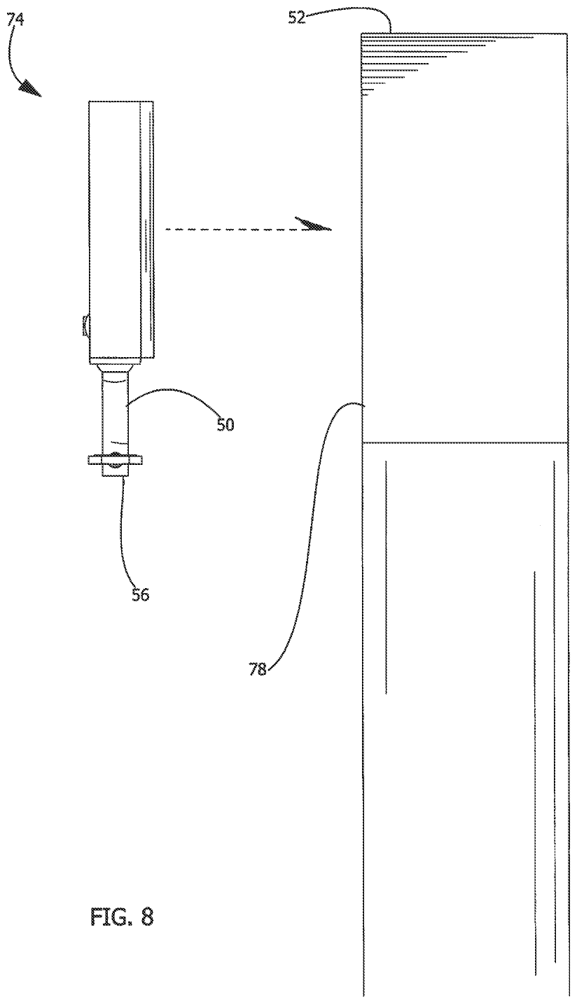

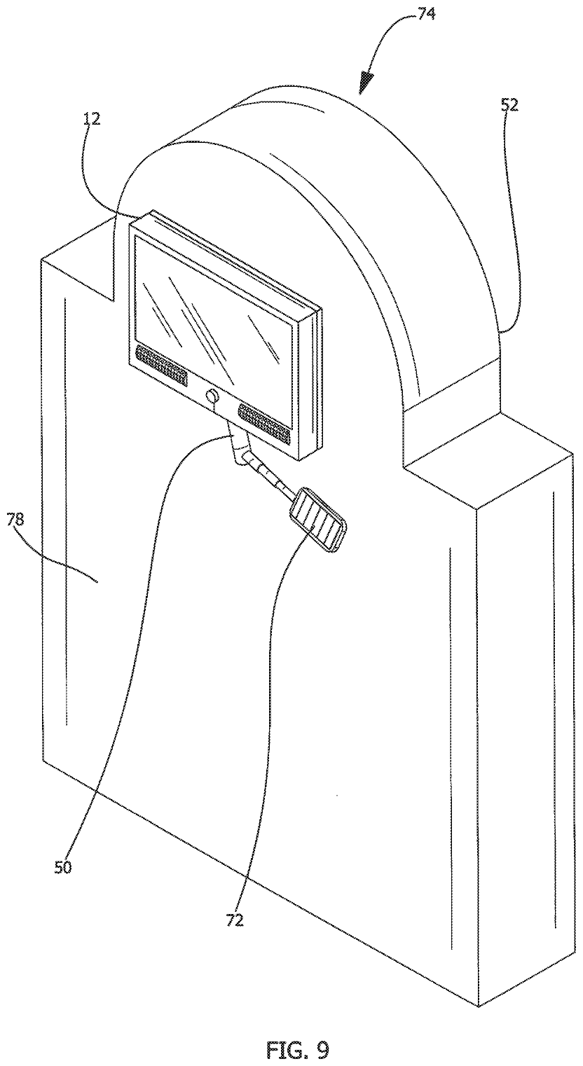

With reference now to the drawings, and in particular to FIGS. 1 through 9 thereof, a new gravesite device embodying the principles and concepts of an embodiment of the disclosure and generally designated by the reference numeral 10 will be described.

As best illustrated in FIGS. 1 through 9, the multimedia gravesite memorial device 10 generally comprises a multimedia unit 12 has a display 14 for displaying imagery 16 and a plurality of speakers 18 for emitting audible sounds. The multimedia unit 12 is in remote communication with a personal electronic device 20 thereby facilitating the multimedia unit 12 to download and subsequently store data from the personal electronic device 20. In this way the multimedia unit 12 can store imagery 16 of a loved one and audio of the loved one speaking thereby facilitating the display 14 to display the imagery 16 of the loved and facilitating the plurality of speakers 18 to emit the audio of the loved one speaking.

The multimedia unit 12 comprises a housing 22 that has a front wall 24, a back wall 26 and an outer wall 28 extending between the front wall 24 and the back wall 26. The outer wall 28 has a bottom side 30 and a recess 32 extends into the bottom side 30. The recess 32 has a bounding surface 34 that is concavely arcuate with respect to the bottom side 30 and the recess 32 is centrally located along the bottom side 30. Furthermore, the outer wall 28 has an annular ring 36 extending downwardly from the bottom side 30 and the annular ring 36 is oriented to surround the recess 32.

The multimedia unit 12 includes a processor 38 that is integrated into the housing 22 and the processor 38 includes an electronic memory 40 for storing digital data. A first transceiver 42 is integrated into the housing 22 and the first transceiver 42 is electrically coupled to the processor 38. The first transceiver 42 is in wireless communication with the personal electronic device 20 thereby facilitating the electronic memory 40 to store data received from the personal electronic device 20. The first transceiver 42 may comprise a radio frequency transceiver or the like and the first transceiver 42 may employ Bluetooth communication protocols. The multimedia unit 12 includes a second transceiver 44 that is integrated into the housing 22 and the second transceiver 44 is electrically coupled to the processor 38. The second transceiver 44 is in wireless communication with a global positioning system 46 thereby facilitating the second transceiver 44 to receive the physical location of the multimedia unit 12 from the global positioning system 46. In this way the multimedia unit 12 can be located in the event of theft.

The display 14 is integrated into the front wall 24 of the housing 22 and the display 14 is electrically coupled to the processor 38 such that the display 14 is facilitated to display the imagery 16 of the loved one that is contained in the data stored in the electronic memory 40. Each of the plurality of speakers 18 is integrated into the front wall 24 of the housing 22 and each of the plurality of speakers 18 is electrically coupled to the processor 38 to emit the audio of the loved one speaking that is contained in the data stored in the electronic memory 40. Additionally, each of the plurality of speakers 18 is positioned between the display 14 and the bottom side 30 of the outer wall 28 of the housing 22. A plurality of speaker covers 45 is each attached to and curve outwardly from the front wall 24 of the housing 22 and each of the plurality of speaker covers 45 is foraminous. Additionally, each of the speaker covers 45 is aligned with a respective one of the plurality of speakers 18 to protect the respective speaker 18 from being damaged.

The multimedia unit 12 includes a power supply 44 that is integrated into the housing 22 and the power supply 44 is electrically coupled to the processor 38. The power supply 44 includes a rechargeable battery 47 that is positioned within the housing 22 and the rechargeable battery 47 is electrically coupled to the processor 38. The power supply 44 includes a power button 48 that is movably integrated into the front wall 24 of the housing 22 and the power button 48 is electrically coupled to the processor 38. The processor 38 is turned on when the power button 48 is manipulated into an on condition and the processor 38 is turned off when the power button 48 is manipulated into an off condition.

A pole 50 is pivotally mounted to the multimedia unit 12 such that the pole 50 can be driven into the ground adjacent to a tombstone 52 of the loved one thereby facilitating the multimedia unit 12 to be visible to visitors of the tombstone 52. In this way the visitors can view the imagery 16 of the loved one and hear the audio of the loved one speaking. The pole 50 has an upper end 54, a bottom end 56 and a stem 58 extending laterally away from the pole 50. The stem 58 is positioned between the upper end 54 and the bottom end 56 and the stem 58 includes a plurality of telescopic sections 60 that slidably engage each other such that the stem 58 has a telescopically adjustable length. Additionally, the bottom end 56 tapers to a point to facilitate the bottom end 56 to penetrate the ground and the pole 50 may have a length ranging between approximately 60.0 cm and 90.0 cm.

A ball 62 is attached to the upper end 54 of the pole 50 and the ball 62 is positioned in the recess 32 in the bottom side 30 of the outer wall 28 of the housing 22. In this way the pole 50 is pivotally retained on the housing 22 thereby facilitating the housing 22 to be positioned at a variety of angles on the pole 50. An opening 64 into the recess 32 has a diameter that is less than a diameter of the ball 62 thereby inhibiting the ball 62 from being removed from the recess 32. A paddle 66 is provided that has a top surface 68 and a perimeter edge 70 and the perimeter edge 70 is continuously arcuate about a longitudinal axis of the paddle 66 such that the paddle 66 has an ovoid shape. Additionally, the perimeter edge 70 is coupled to a distal end 71 of the stem 58 that is attached to the pole 50 has the top surface 68 is directed upwardly. A solar panel 72 is attached to the top surface 68 of the paddle 66 such that the solar panel 72 is exposed to sunlight. The solar panel 72 is electrically coupled to the rechargeable battery 47 via an electrical conductor for charging the rechargeable battery 47.

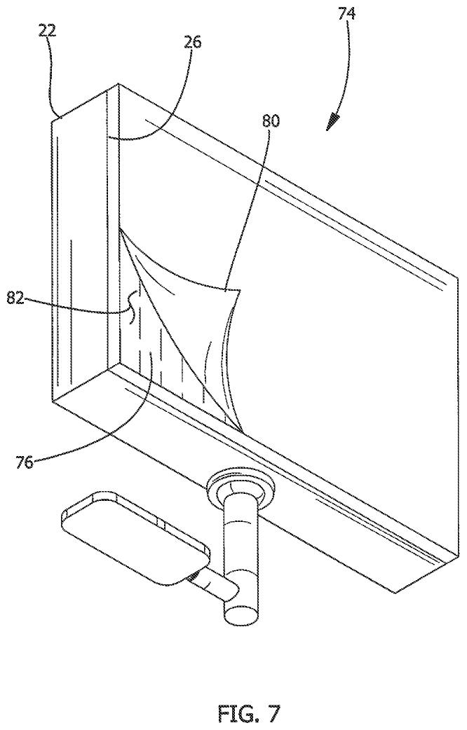

In an alternative embodiment 74 as is shown in FIGS. 7 through 9, the bottom end 56 of the pole 50 is flattened and the stem 58 is positioned adjacent to the bottom end 56 of the pole 50. An adhesive layer 76 is applied to the back wall 26 of the housing 22 and the adhesive layer 76 can be adhered to a front face 78 of the tombstone 52 for mounting the housing 22 to the tombstone 52. In this way the multimedia unit 12 can be displayed in lieu of being supported on the pole 50. Continuing in the alternative embodiment 74, a protective sheet 80 is removably applied to an exposed surface 82 of the adhesive layer 76 such that the protective sheet 80 completely covers the exposed surface 82 thereby inhibiting the exposed surface 82 from adhering.

In use, the personal electronic device 20 is synched with the first transceiver 42 to facilitate the video of the loved one and the audio of the loved one to be downloaded into the electronic memory 40. The pole 50 is driven into the ground at a point located adjacent to a tombstone 52 at the loved one's gravesite thereby facilitating the multimedia unit 12 to be prominently displayed. In this way visitors to the gravesite can enjoy viewing the video of the loved one as well as listening to the audio of the loved one thereby enhancing fond memories of the loved one. As is shown in the alternative embodiment 74, the adhesive layer 76 can be adhered to the tombstone 52 at any desired location on the tombstone 52 to display the multimedia unit 12 on the tombstone 52 in lieu of displaying the multimedia unit 12 on the pole 50.

With respect to the above description then, it is to be realized that the optimum dimensional relationships for the parts of an embodiment enabled by the disclosure, to include variations in size, materials, shape, form, function and manner of operation, device and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A multimedia gravesite memorial device for displaying imagery and audible sounds in memoriam of a decedent, said device comprising:
a multimedia unit having a display for displaying imagery and a plurality of speakers for emitting audible sounds, said multimedia unit being in remote communication with a personal electronic device thereby facilitating said multimedia unit to download and subsequently store data from said personal electronic device wherein said multimedia unit is configured to store imagery of a loved one and audio of the loved one speaking thereby facilitating said display to display the imagery of the loved and facilitating said plurality of speakers to emit the audio of the loved one speaking; and
a pole being pivotally mounted to said multimedia unit wherein said pole is configured to be driven into the ground adjacent to a tombstone of the loved one thereby facilitating said multimedia unit to be visible to visitors of the tombstone such that the visitors can view the imagery of the loved one and hear the audio of the loved one speaking.

2. The device according to claim 1, wherein said multimedia unit comprises a housing having a front wall and a back wall and an outer wall extending between said front wall and said back wall, said outer wall having a bottom side, said bottom side having a recess extending into said bottom side, said recess having a bounding surface being concavely arcuate with respect to said bottom side, said recess being centrally located along said bottom side, said outer wall having an annular ring extending downwardly from said bottom side, said annular ring being oriented to surround said recess.

3. The device according to claim 2, wherein said multimedia unit includes:
a processor being integrated into said housing, said processor including an electronic memory for storing digital data;
a first transceiver being integrated into said housing, said first transceiver being electrically coupled to said processor, said first transceiver being in wireless communication with said personal electronic device thereby facilitating said electronic memory to store data received from said personal electronic device; and
a second transceiver being integrated into said housing, said second transceiver being electrically coupled to said processor, said second transceiver being in wireless communication with a global positioning system thereby facilitating said second transceiver to receive the physical location of said multimedia unit from said global positioning system wherein said second transceiver is configured to facilitate said multimedia unit to be located in the event of theft.

4. The device according to claim 3, wherein:
said display is integrated into said front wall of said housing, said display being electrically coupled to said processor wherein said display is configured to display the imagery of the loved one that is contained in said data stored in said electronic memory; and
each of said plurality of speakers is integrated into said front wall of said housing, each of said plurality of speakers being electrically coupled to said processor wherein each of said plurality of speakers is configured to emit the audio of the loved one speaking that is contained in said data stored in said electronic memory, each of said plurality of speakers being positioned between said display and said bottom side of said outer wall of said housing.

5. The device according to claim 3, further comprising a power supply being integrated into said housing, said power supply being electrically coupled to said processor, said power supply including:
a rechargeable battery being positioned within said housing, said rechargeable battery being electrically coupled to said processor; and
a power button being movably integrated into said front wall of said housing, said power button being electrically coupled to said processor, said processor being turned on when said power button is manipulated into an on condition, said processor being turned off when said power button is manipulated into an off condition.

6. The device according to claim 2, wherein:
said pole has an upper end and a bottom end and a stem extending laterally away from said pole, said stem being positioned between said upper end and said bottom end, said stem including a plurality of telescopic sections that slidably engage each other such that said stem has a telescopically adjustable length, said bottom end tapering to a point wherein said bottom end is configured to penetrate the ground; and
said device includes a ball being attached to said upper end of said pole, said ball being positioned in said recess in said bottom side of said outer wall of said housing such that said pole is pivotally retained on said housing thereby facilitating said housing to be positioned at a variety of angles on said pole, an opening into said recess having a diameter being less than a diameter of said ball thereby inhibiting said ball from being removed from said recess.

7. The device according to claim 6, further comprising:
a rechargeable battery being positioned in said housing;
a paddle having a top surface and a perimeter edge, said perimeter edge being continuously arcuate about a longitudinal axis of said paddle such that said paddle has an ovoid shape, said perimeter edge being coupled to a distal end of said stem that is attached to said pole having said top surface being directed upwardly; and
a solar panel being attached to said top surface of said paddle wherein said solar panel is configured to be exposed to sunlight, said solar panel being electrically coupled to said rechargeable battery via an electrical conductor for charging said rechargeable battery.

8. A multimedia gravesite memorial device for displaying imagery and audible sounds in memoriam of a decedent, said device comprising:
a multimedia unit having a display for displaying imagery and a plurality of speakers for emitting audible sounds, said multimedia unit being in remote communication with a personal electronic device thereby facilitating said multimedia unit to download and subsequently store data from said personal electronic device wherein said multimedia unit is configured to store imagery of a loved one and audio of the loved one speaking thereby facilitating said display to display the imagery of the loved and facilitating said plurality of speakers to emit the audio of the loved one speaking, said multimedia unit comprising:
a housing having a front wall and a back wall and an outer wall extending between said front wall and said back wall, said outer wall having a bottom side, said bottom side having a recess extending into said bottom side, said recess having a bounding surface being concavely arcuate with respect to said bottom side, said recess being centrally located along said bottom side, said outer wall having an annular ring extending downwardly from said bottom side, said annular ring being oriented to surround said recess;
a processor being integrated into said housing, said processor including an electronic memory for storing digital data;
a first transceiver being integrated into said housing, said first transceiver being electrically coupled to said processor, said first transceiver being in wireless communication with said personal electronic device thereby facilitating said electronic memory to store data received from said personal electronic device;
a second transceiver being integrated into said housing, said second transceiver being electrically coupled to said processor, said second transceiver being in wireless communication with a global positioning system thereby facilitating said second transceiver to receive the physical location of said multimedia unit from said global positioning system wherein said second transceiver is configured to facilitate said multimedia unit to be located in the event of theft;
wherein said display is integrated into said front wall of said housing, said display being electrically coupled to said processor wherein said display is configured to display the imagery of the loved one that is contained in said data stored in said electronic memory;
wherein each of said plurality of speakers is integrated into said front wall of said housing, each of said plurality of speakers being electrically coupled to said processor wherein each of said plurality of speakers is configured to emit the audio of the loved one speaking that is contained in said data stored in said electronic memory, each of said plurality of speakers being positioned between said display and said bottom side of said outer wall of said housing; and
a power supply being integrated into said housing, said power supply being electrically coupled to said processor, said power supply including:
a rechargeable battery being positioned within said housing, said rechargeable battery being electrically coupled to said processor; and
a power button being movably integrated into said front wall of said housing, said power button being electrically coupled to said processor, said processor being turned on when said power button is manipulated into an on condition, said processor being turned off when said power button is manipulated into an off condition;
a pole being pivotally mounted to said multimedia unit wherein said pole is configured to be driven into the ground adjacent to a tombstone of the loved one thereby facilitating said multimedia unit to be visible to visitors of the tombstone such that the visitors can view the imagery of the loved one and hear the audio of the loved one speaking, said pole having an upper end and a bottom end and a stem extending laterally away from said pole, said stem being positioned between said upper end and said bottom end, said stem including a plurality of telescopic sections that slidably engage each other such that said stem has a telescopically adjustable length, said bottom end tapering to a point wherein said bottom end is configured to penetrate the ground;
a ball being attached to said upper end of said pole, said ball being positioned in said recess in said bottom side of said outer wall of said housing such that said pole is pivotally retained on said housing thereby facilitating said housing to be positioned at a variety of angles on said pole, an opening into said recess having a diameter being less than a diameter of said ball thereby inhibiting said ball from being removed from said recess;
a paddle having a top surface and a perimeter edge, said perimeter edge being continuously arcuate about a longitudinal axis of said paddle such that said paddle has an ovoid shape, said perimeter edge being coupled to a distal end of said stem that is attached to said pole having said top surface being directed upwardly; and
a solar panel being attached to said top surface of said paddle wherein said solar panel is configured to be exposed to sunlight, said solar panel being electrically coupled to said rechargeable battery via an electrical conductor for charging said rechargeable battery.

9. The device according to claim 8, wherein:
said bottom end of said pole is flattened;
said stem is positioned adjacent to said bottom end of said pole;
said device includes an adhesive layer being applied to said back wall of said housing wherein said adhesive layer is configured to be adhered to a front face of the tombstone for mounting said housing to the tombstone; and
a protective sheet being removably applied to an exposed surface of said adhesive layer such that said protective sheet completely covers said exposed surface thereby inhibiting said exposed surface from adhering.
